(19) United States
(12) Patent Application Publication
(10) Pub. No.: US 2006/0144867 A1
(43) Pub. Date: Jul. 6, 2006

(54) Dispenser

(75) Inventors: Bernard Colin Jarvis, South Anston (GB); Freya Dale Shepherd, Crosspool (GB)

Correspondence Address: GOMEZ INTERNATIONAL PATENT OFFICE, LLC, 1501 N. RODNEY STREET, SUITE 101, WILMINGTON, DE, 19806, US

(73) Assignee: SUPAPLANTS LIMITED

(21) Appl. No.: 10/544,075

(22) PCT Filed: Jan. 27, 2004
(86) PCT No.: PCT/GB04/00328

§ 371 Date: Jul. 30, 2005

(30) Foreign Application Priority Data
Jan. 31, 2003 (GB) 0302272.0
Feb. 18, 2003 (GB) 0303641.5

(51) Int. Cl. B67D 5/40

(52) U.S. Cl. 222/372

(57) ABSTRACT

A dispenser comprising a reservoir containing a viscous aqueous planting fluid and a dispensing head comprising an attachment means for the fluid-tight attachment of the reservoir, and one or more walls defining a dispensing channel that connects the interior of the reservoir to the exterior of the dispensing head, can be used for dispensing in situ a viscous aqueous planting fluid into a plant container.

This invention is concerned with viscous aqueous planting fluids, such as viscous aqueous propagating fluids. More particularly, the invention concerns a dispenser containing a viscous aqueous planting fluid and a method of dispensing a viscous aqueous planting fluid into a container, such as a propagating container.

Viscous aqueous propagating fluids, such as translucent, aqueous thixotropic rooting gels, for rooting plant cuttings are well known.

Translucent, aqueous thixotropic rooting gels are described in UK-A-2171986, UK-A-2188044 and UK-A-2229716. Such gels have been provided in single propagating pots and in multicellular propagating trays, such as disclosed in UK-A-2194124, which pots or trays may have been modified to screen the gel from light of certain wavelengths, as disclosed in UK-A-2229716.

The propagating containers (pots and trays) for the rooting gels are typically made of a plastics material, such as polypropylene, which may be transparent, and have a wall thickness in the range of 0.3 to 0.7 mm.

The gel filled propagating containers are manufactured by a process involving dispensing a required volume of a bulk produced propagating gel into a container and then sealing the container with a plastics film or metal foil lid, thereby to prevent the gel from escaping accidentally from the container. This method of manufacture can be compared to the process generally used for manufacturing containers of yoghurt, cream or other viscous-liquid dairy products available from most supermarkets.

To prevent the gel filled container from accidental damage during handling, transporting and displaying, the container is then housed in a card envelope. The card envelope is usually sufficiently robust so as to prevent either the container from bursting or the lid from being pierced if dropped or knocked.

At the point of use, the container is removed from the envelope, a hole is made in the lid, or the lid completely removed, and the relevant end portion of a prepared cutting from a plant, such as a houseplant or softwood, is inserted into the rooting gel to an appropriate depth, leaving a portion of the cutting exposed above the surface of the gel. The cutting and container, optionally within a propagator, is then left in an appropriate environment e.g. a green house, propagating shed or window-ledge, for a period of time, after which roots may be seen sprouting from the cutting into the gel. Once sufficient roots have grown, the rooted cutting is carefully removed from the container and potted-on into a larger pot containing conventional growing medium. The spent container and gel remaining therein is then usually thrown away or otherwise disposed of

As the process of manufacturing and packing the gel-filled containers to avoid damage is complex, the end product tends to be expensive to produce. Further, as the packed gel-filled containers are relatively bulky, they are consequently relatively expensive to transport, store and display.

Moreover, although the rooting gel is designed to propagate roots on cuttings selected from a broad range of houseplants and softwoods, there are still many other plants that will not propagate in this “generic” gel. Such other plants require more or different nutrients, chemicals and/or growth regulators to be included in the gel for them to initiate propagation. Whilst it is desirable to enable wholesalers and retailers to offer different gels for different plants or group of plants, the present method of manufacturing and packing the containers, being complex and bulky, and therefore expensive, does not readily lend itself to product diversification.

It is an object of the present invention to overcome one or more of the above problems.

The present invention, in its various aspects, is as set out in the accompanying claims.

In one aspect of the present invention, there is provided a dispenser comprising:
a) a dispensing head comprising an attachment means, for the fluid-tight attachment to the dispensing head of a reservoir containing a viscous aqueous planting fluid, and one or more walls defining a dispensing channel that connects the interior of the reservoir to the exterior of the dispensing head; and
b) a reservoir, comprising a viscous aqueous planting fluid, attached to said dispensing head by said attachment means.

The viscous aqueous planting fluid is preferably a viscous aqueous propagating fluid. Accordingly, one particularly preferred embodiment of this aspect of the present invention provides a dispenser comprising:
a) a dispensing head comprising an attachment means, for the fluid-tight attachment to the dispensing head of a reservoir of a viscous aqueous propagating fluid, and one or more walls defining a dispensing channel that connects the interior of the reservoir to the exterior of the dispensing head; and
b) a reservoir, comprising a viscous aqueous propagating fluid, attached to said dispensing head by said attachment means.

In another aspect of the present invention, there is provided a kit of parts for forming a dispenser of viscous aqueous planting fluid, the kit comprising:
a) a dispensing head comprising an attachment means suitable for the fluid-tight attachment to the dispensing head of a reservoir of a viscous aqueous planting fluid, and one or more walls defining a dispensing channel that in use connects the interior of the reservoir to the exterior of the dispensing head; and
b) a reservoir, comprising a viscous aqueous planting fluid, for attachment to said dispensing head by said attachment means.

The viscous aqueous planting fluid is preferably a viscous aqueous propagating fluid. Accordingly, one particularly preferred embodiment of this aspect of the present invention provides a kit of parts for forming a dispenser of viscous aqueous propagating fluid, the kit comprising:
a) a dispensing head comprising an attachment means suitable for the fluid-tight attachment to the dispensing head of a reservoir of a viscous aqueous propagating fluid, and one or more walls defining a dispensing channel that in use connects the interior of the reservoir to the exterior of the dispensing head; and
b) a reservoir, comprising a viscous aqueous propagating fluid, for attachment to said dispensing head by said attachment means.

The dispenser may be sold along with one or more plant containers, such as a propagating pot or tray. Alternatively, the kit may additionally comprise one or more plant containers, such as a propagating pot or tray.

In another aspect, the present invention provides a method of dispensing a viscous aqueous planting fluid, such as a viscous aqueous propagating fluid, into a plant container, such as a propagating container, which method comprises:
a) filling the reservoir of a dispenser with a viscous aqueous planting fluid, said dispenser comprising a reservoir for said fluid and a dispensing head comprising an attachment means for the fluid-tight attachment of the reservoir and one or more walls defining a dispensing channel that connects the interior of the reservoir to the exterior of the dispensing head; and
b) dispensing from said dispenser an amount of said fluid into a plant container.

In another aspect, the invention provides the use of a dispenser comprising a reservoir for receiving a viscous aqueous planting fluid and a dispensing head comprising an attachment means for the fluid-tight attachment of the reservoir, and one or more walls defining a dispensing channel that connects the interior of the reservoir to the exterior of the dispensing head, for dispensing in situ a viscous aqueous planting fluid into a plant container.

In another aspect, the present invention provides a method of propagating a cutting from a plant, which method comprises:
a) filing the reservoir of a dispenser with a viscous aqueous propagating fluid, said dispenser comprising a reservoir for said fluid and a dispensing head comprising an attachment means for the fluid-tight attachment of the reservoir, and one or more walls defining a dispensing channel that connects the interior of the reservoir to the exterior of the dispensing head;
b) dispensing from said dispenser an amount of said fluid into a container;
c) preparing a cutting of a plant and inserting the relevant end of the cutting into the propagating fluid in the container.

Once the cutting has been inserted into the fluid and before such time as any root may become established on the cutting, the cutting may be removed and inserted into a separate container, the propagating container, containing a relevant propagating medium. For example, the cutting may be simply dipped into the fluid and then potted into a propagating container, containing a conventional growth medium. Alternatively, in a preferred embodiment, the cutting may be retained in the fluid and propagated therein.

An aqueous planting fluid as used herein is an aqueous fluid suitable for sustaining plant life. Preferably the fluid is homogenous at the plant cell level. A fluid comprising gelled polyacrylamide crystals is not considered homogenous at the plant cell level, as interstices, which may be filled with water, exist between the expanded polymer particles. Lack of homogeneity at the plant cell level may be detrimental to sustaining plant life for over five days e.g. over a week or more. The planting fluid is preferably transparent.

Preferably, the planting fluid has at room temperature (20° C.) a viscosity similar to or greater than the viscosity of ketchup or salad cream. Depending upon the size of the cutting and the depth to which it is inserted into the fluid, the fluid may be sufficiently viscous for a plant cutting to be inserted vertically into the fluid and the cutting maintain that position without extra support.

In addition to the nutrients, if any, which may be present in the basic planting fluid (i.e. water and rheology modifier), the planting fluid preferably comprises at least one plant nutrient which is suitable for sustaining plant life e.g. the fluid may comprise additional Ca, Mg, K, Mn, Cu, Zn, Mo, Fe, S, P, N and/or B.

The planting fluid is preferably a propagating fluid, which is a planting fluid comprising at least one plant growth regulator, such as a hormone, which is suitable for encouraging growth of roots on a plant cutting. In one particular embodiment of the present invention, the planting fluid comprises both of at least one plant nutrient and at least one plant growth regulator, i.e. the fluid is a propagating fluid comprising at least one plant nutrient.

Preferably, the viscous aqueous planting fluid is an aqueous thixotropic gel, more preferably an aqueous inorganic thixotropic gel. Preferably, the inorganic thixotropic gel comprises an hydrated magnesium silicate, such as a synthetic hectorite. Preferably, the inorganic thixotropic gel comprises a gel such as disclosed in UK-A-2171986, UK-A-2188044 or UK-A-2229716.

The dispenser may, for example, be in the form of a squeeze bottle, a pump-action dispenser, a pressurised canister, or a pressurized, gravity fed or pumped tank.

The dispenser is preferably suitable for hand held operation.

In one embodiment, the dispenser is in the form of a squeeze bottle including a reservoir in the form of flexible flask portion, which contains the viscous aqueous planting fluid and which is intended to be compressed by the user, and a dispensing head in the form of a cap attached thereto. The cap preferably comprises a nozzle which connects the interior of the flask to the exterior of the cap. Upon compression of the flask, the viscous aqueous planting fluid contained therein is forced through the nozzle. Examples of squeeze bottles suitable for use in the present invention include shampoo and bath gel dispensers, liquid washing detergent dispensers and toothpaste tubes.

In another embodiment, the dispenser is in the form of a squeeze bottle including a reservoir in the form of flexible flask portion, which contains the viscous aqueous propagating fluid and which is intended to be compressed by the user, and a dispensing head in the form of a cap attached thereto. The cap preferably comprises a nozzle which connects the interior of the flask to the exterior of the cap. Upon compression of the flask, the viscous aqueous propagating fluid contained therein is forced through the nozzle. Examples of squeeze bottles suitable for use in the present invention include shampoo and bath gel dispensers, liquid washing detergent dispensers and tooth paste tubes.

In another embodiment, the dispenser is in the form of a pump-action dispenser, such as typically used for dispensing toothpaste or for gunning mastics, sealants and adhesives. For example, the dispenser disclosed in U.S. Pat. No. 5,305,922 and U.S. Pat. No. 6,047,862 may be suitable for use in the present invention.

The provision of the planting fluid in a dispenser enables the user to dispense the fluid into any container that is suitable for purpose. Further, providing the planting fluid in a dispenser enables plant containers containing e.g. cuttings, which may be several days, weeks or months old, and where the planting fluid has become dehydrated or otherwise present in insufficient quantities, to be replenished or supplemented with new fluid. Furthermore, by providing propagating fluid in a dispenser, the manufacturing process is simpler and the packing requirements are reduced. Further, there is less wastage of spent propagating containers, as they can be readily reused. Moreover, providing the propagating fluid in a dispenser enables the user to dispense the fluid into any container that is suitable for purpose, rather than being restricted to using only the propagating containers supplied with the gel as was the case prior to this invention. Further, there is a tendency to use less gel, so making the propagating process more efficient. Further, because the manufacturing process is simplified, it is now more convenient to offer a broader range of propagating gels. Furthermore, providing the propagating fluid in a dispenser, enables propagating containers containing cuttings, which may be several days, weeks or months old, and where the propagating fluid has become dehydrated or otherwise present in insufficient quantities, to be replenished or supplemented with new fluid.

In yet another aspect, the present invention provides a method of potting-on a rooted plant, which method comprises:
a) removing a rooted plant from a growing medium, such as either a conventional soil or compost growing medium or an aqueous thixotropic rooting gel;
b) dispensing from a dispenser, including a reservoir containing a viscous aqueous planting fluid and a dispensing head comprising an attachment means for the fluid-tight attachment to the reservoir, and one or more walls defining a dispensing channel that connects the interior of the reservoir to the exterior of the dispensing head, an amount of said fluid into a container, preferably into a container having transparent walls; and
c) burying the roots of the plant in said fluid in said container.

When the rooted plant is removed from a conventional growing medium, but before the roots are buried in the planting fluid, a proportion of the medium attached to the roots is preferably removed e.g. by gently shaking or tapping of the plant or by washing the roots with water. Preferably, the roots are washed with water until the roots are visibly clean of growing medium.

The invention in one particularly preferred aspect will now be further described by way of example only.

A 1000 ml plastics squeeze bottle (code SHR01014), available from Inblow Form Limited, Wrexham, Wales, is washed and rinsed to be free of any production residues. The bottle, which constitutes a reservoir, is filled with a “gel2root™” inorganic thixotropic propagating gel, available from SupaPlants Limited, Sheffield, England. Once the reservoir is full, a dispensing head, consisting of a flip-top, screw-cap plastics closure including a dispensing nozzle (code ZP3949), available from UCP/Zeller, Norwich, England, is positioned on the reservoir to form the completed dispenser.

A used yoghurt pot (6 cm square top) is washed and rinsed to be free of any yoghurt residues and then dried.

An amount of “gel2root™” propagating gel is then dispensed from the squeeze bottle into the bottom of the yoghurt pot until the depth of gel in the pot is about 3 cm.

The prepared ends of 6 fuchsia cuttings, each approximately 7.5 cm long, may then inserted vertically into the propagating gel around the edge of the pot to a depth of about 2 cm. The gel may be of sufficient viscosity that the fuchsia cuttings remain standing vertically in the gel without requiring further support.

The open end of the pot and the cuttings may then covered with a small transparent polyethylene bag, held in position with a rubber band. The bag is provided with two ventilation holes.

After about 10 days, small roots may be seen growing from the base of the cuttings into the gel. After 30 days, a vibrant root growth is seen at the bottom of the cuttings and the cuttings are transplanted: three rooted cuttings are potted-on, each into a 6 cm square top conventional plastics plant pot containing a conventional soil-based potting compost (John Innes No 2), and the remaining three rooted cuttings are potted-on each into a 6 cm square yoghurt pot containing an aqueous viscous planting fluid (gel2root™, available from SupaPlants, England).

Rather than disposing of the propagating gel remaining in the yoghurt pot, because only a small amount of gel is removed on the roots of the cuttings and the cuttings may not significantly deplete the amount of water in the gel, a further small amount of gel is then dispensed into the pot from the squeeze dispenser to provide an even depth of gel in the pot, approximately 3 cm deep. A number of freshly prepared fuchsia cuttings are then inserted into the gel in the pot and the open end of the pot and cuttings covered with the polyethylene bag.

This example of the present invention demonstrates the enabling of the efficient use of propagating gel. Further, the provision of the gel in a dispenser is a much more efficient manufacturing process than the previously used method, which relied upon the provision of sealed pots in a cardboard protecting envelope. Furthermore, the example demonstrates that any non-customized container, such as one that was previously used as a yoghurt pot, can be used as a propagating container, provided that it is suitable for purpose. Moreover, the example demonstrates a method of potting-on rooted cuttings into a planting fluid.

1. (canceled)

2. (canceled)

3. (canceled)

4. (canceled)

5. (canceled)

6. (canceled)

7. (canceled)

8. A kit of parts for forming a dispenser of viscous aqueous planting fluid, wherein the kit comprises:
a) a dispensing head comprising an attachment means suitable for the fluid-tight attachment to the dispensing head of a reservoir of a viscous aqueous planting fluid, and one or more walls defining a dispensing channel that in use connects the interior of the reservoir to the exterior of the dispensing head; and
b) a reservoir, comprising a viscous aqueous planting fluid, for attachment to said dispensing head by said attachment means.

9. A kit as claimed in claim 8, wherein the dispenser is in the form of a squeeze bottle, a pump-action dispenser, a pressurized canister, or a pressurized, gravity fed or pumped tank.

10. A kit as claimed in claim 9, wherein the dispenser is hand-held.

11. A kit as claimed in claim 10, wherein the dispenser is in the form of a hand-held squeeze bottle.

12. A kit as claimed in claim 8, wherein said kit additionally comprises at least one plant container.

13. A kit as claimed in claim 12, wherein the plant container is a pot or tray.

14. A kit as claimed in claim 8, wherein the planting fluid comprises at least one plant nutrient.

15. A kit as claimed in claim 8, wherein the planting fluid is a propagating fluid.

16. A kit as claimed in claim 8, wherein the fluid is homogenous at the plant cell level.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method of propagating a cutting from a plant, which method comprises:
a) filling the reservoir of a dispenser with a viscous aqueous propagating fluid, said dispenser comprising a reservoir for said fluid and a dispensing head comprising an attachment means for the fluid-tight attachment of the reservoir, and one or more walls defining a dispensing channel that connects the interior of the reservoir to the exterior of the dispensing head;
b) dispensing from said dispenser an amount of said fluid into a container;
c) preparing a cutting of a plant and inserting the relevant end of the cutting into the propagating fluid in the container.

31. A method as claimed in claim 30, wherein the planting fluid comprises at least one plant nutrient.

32. A method as claimed in claim 30, wherein the planting fluid is a propagating fluid.

33. A method as claimed in claim 30, wherein the fluid is homogenous at the plant cell level.

34. A method as claimed in claim 30, wherein the dispenser is in the form of a squeeze bottle, a pump-action dispenser, a pressurized canister, or a pressurized, gravity fed or pumped tank.

35. (canceled)

36. A method as claimed in claim 34, wherein the dispenser is in the form of a hand-held squeeze bottle.

37. (canceled)

38. (canceled)

39. (canceled)

40. (canceled)

41. (canceled)

42. (canceled)

43. (canceled)

44. A hand-held squeeze bottle dispenser comprising:
a) a dispensing head comprising an attachment means, for the fluid-tight attachment to the dispensing head of a reservoir containing a viscous aqueous planting fluid, and one or more walls defining a dispensing channel that connects the interior of the reservoir to the exterior of the dispensing head, wherein the dispenser head is a cap comprising a nozzle; and
b) a reservoir, comprising a viscous aqueous planting fluid, attached to said dispensing head by said attachment means, wherein the reservoir is a flexible flask;
wherein the viscous aqueous planting fluid is an aqueous thixotropic gel.

45. A dispenser as claimed in claim 44, wherein the planting fluid comprises at least one plant nutrient.

46. A dispenser as claimed in claim 44, wherein the planting fluid is a propagating fluid.
